(19) United States
(12) Patent Application Publication
(10) Pub. No.: US 2009/0008252 A1
(43) Pub. Date: Jan. 8, 2009

(54) Ozone generating device

(75) Inventor: Jeff Ifland, Cupertino, CA (US)

Correspondence Address: PATENT OFFICE OF DR. CHUNG S. PARK, P. O. BOX 62312, SUNNYVALE, CA, 94088-2312, US

(73) Assignee: Amarante Technologies, Inc., Santa Clara, CA (US)

(21) Appl. No.: 11/897,390

(22) Filed: Aug. 29, 2007

Related U.S. Application Data
(63) Continuation-in-part of application No. 11/825,183, filed on Jul. 3, 2007, now abandoned.

(51) Int. Cl. G01N 27/26; C25B 9/00

(52) U.S. Cl. 204/431; 204/242; 204/274

(57) ABSTRACT

Devices for generating and storing ozone. A device for generating ozone includes: at least one elongated electrode unit including an outer tubular dielectric member and an inner conducting member having a longitudinal axis; and one or more elongated electrode tubes disposed circumferentially about the longitudinal axis. Each of the electrode tubes is arranged in parallel to the electrode unit. When an electrical potential is applied across the conducting member and electrode tubes during operation, plasma is established between the dielectric member and electrode tubes. The plasma converts oxygen gas into ozone gas.

### CROSS REFERENCE TO RELATED APPLICATIONS

This application is related to co-pending U.S. application Ser. No. 11/825,157, filed on Jul. 3, 2007, entitled “Systems And Methods For Generating And Storing Ozone” which is hereby incorporated by reference in its entirety.

### BACKGROUND

The present invention generally relates to ozone synthesis, more particularly, to generating and storing ozone.

Ozone (O₃) is a form of oxygen that has three atoms per molecule rather than two atoms as found in bimolecular oxygen. Each ozone molecule decomposes into molecular oxygen (O₂), releasing an extra oxygen atom. This extra oxygen atom is a strong oxidizing agent and known as a potent bactericide and viricide.

Conventionally, ozone gas is produced as needed at the point of use rather than being produced beforehand and stored, or being purchased and transported to the point of use. This is mainly because ozone gas constantly decays back to oxygen. For instance, the half-life of ozone in a clean stainless steel tank is on the order of a few days at room temperature. As such, for many applications where a constant and/or continuous flow of ozone gas is needed, the ozone gas is produced near or at the point of use. However, there are applications that require a periodic or intermittent use of ozone gas; some requiring a large quantity of ozone gas with a relatively short time notice. For instance, a typical ozone generating system may require several minutes to fill a conventional batch type sterilization chamber, which can limit the operational speed of the entire sterilization system. Therefore, there is a strong need for a system that can readily provide a sufficient quantity of ozone gas for various types of applications upon demand.

### SUMMARY OF THE DISCLOSURE

In one embodiment, a device for generating ozone includes: at least one elongated electrode unit including an outer tubular dielectric member and an inner conducting member having a longitudinal axis; and one or more elongated electrode tubes disposed circumferentially about the longitudinal axis. Each of the electrode tubes is arranged in parallel to the electrode unit. The conducting member and electrode tubes are operative to generate plasma between the dielectric member and electrode tubes when an electrical potential is applied across the conducting member and electrode tubes during operation. The plasma converts oxygen gas into ozone gas.

### BRIEF DESCRIPTION OF THE DRAWINGS

FIG. 1 shows a schematic partial cut away view of an ozone generating device in accordance with one embodiment of the present invention;

FIG. 2 shows a schematic perspective view of an electrode assembly in FIG. 1;

FIG. 3 shows a schematic cross sectional view of the bottom portion of the electrode assembly in FIG. 2;

FIG. 4-6 show schematic cross sectional views of an electrode assembly in FIG. 1, respectively taken along the lines IV-IV, V-V, and VI-VI;

FIGS. 7A and 7B show schematic side and top views of a spacer in FIG. 1;

FIGS. 8A and 8B show schematic side and top views of a retaining ring in FIG. 1;

FIG. 9 shows a schematic transverse cross sectional view of another embodiment of an electrode assembly of the type that might be used in the device of FIG. 1 in accordance with the present invention;

FIG. 10 shows a schematic perspective view of yet another embodiment of an electrode assembly of the type that might be used in the device of FIG. 1 in accordance with the present invention;

FIG. 11 shows a schematic perspective view of still another embodiment of an electrode assembly of the type the type that might be in the device of FIG. 1 in accordance with the present invention;

FIG. 12 shows a schematic cross sectional view of the electrode assembly in FIG. 11, taken along the line XII-XII;

FIGS. 13A-13C are schematic transverse cross sectional views of various embodiments of a high-voltage electrode unit of the type that might be in the device of FIG. 1 in accordance with the present invention; and

FIGS. 14A-14C show various embodiments of a high-voltage feed-through of the type that might be in the device of FIG. 1 in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention because the scope of the invention is best defined by the appended claims.

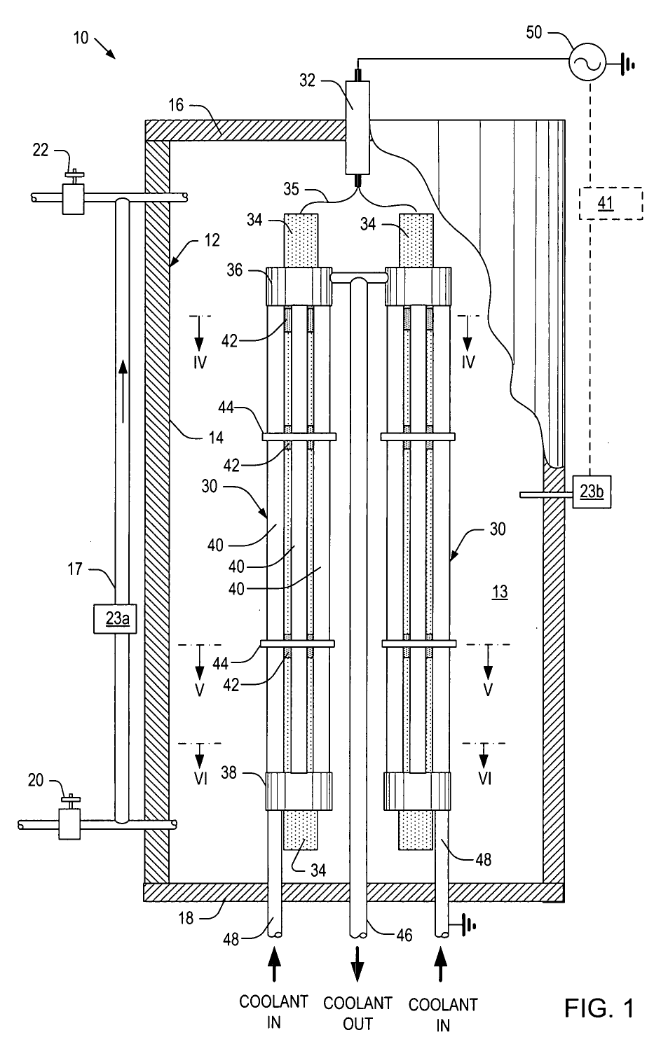

Referring now to FIG. 1, FIG. 1 shows a schematic partial cut away view of an ozone generating device 10 in accordance with one embodiment of the present invention. As depicted, the device includes a tank or container 12 that has a side wall 14, a top end wall 16 and a bottom end wall 18, forming a working space 13 therewithin. The side wall 14 may have a shape of a generally circular cylindrical shell, or other suitable shapes. The container 12 is formed of preferably, but not limited to, sheet material, such as stainless steel, that can stand the caustic effect of ozone.

The device 10 also includes an inlet valve 22 for filling the container 12 with oxygen gas provided by an oxygen source and an outlet valve 20 for discharging ozone/oxygen gas from the container. The outlet valve 20 may be in fluid communication with another device, such as sterilization chamber, that utilizes the ozone transferred thereto through the outlet valve 20. Optionally, a pipe or tube 17 may be coupled to the inlet and outlet valves, generating flow therethrough by a thermal siphon effect, i.e., denser gas moves down in the container 12 causes upward flow in the tube 17. The device 10 includes an ozone sensor to measure the ozone concentration in the container 12. In an exemplary embodiment, the ozone sensor 23a is mounted in the tube 17 to measure the ozone concentration of the gas in the tube 17. In another exemplary embodiment, an ozone sensor 23b is attached directly to the wall 14 of the container 12.

Those skilled in the art will understand that various types of gas may be introduced into the container 12. For instance, oxygen comprises approximately 20% of the volume of air, and air is frequently used in place of pure oxygen gas when the low concentration of oxygen does not militate against the desired result. Likewise, medical grade pure oxygen gas may be introduced into the container 12 if necessary. Thus, hereinafter, for convenience, the term oxygen gas refers to the oxygen gas in its pure form or in a dilute form such as in air.

As depicted in FIG. 1, the inlet valve 22 and outlet valve 20 are secured to the side wall 14. However, it should be apparent to those of ordinary skill that these valves can be disposed in other suitable locations without deviating from the spirit of the present teachings. For instance, the valves can be respectively secured to the top and bottom end walls 16, 18.

The device 10 also includes one or more electrode assemblies 30 disposed in the working space 13. Each electrode assembly 30 has a high-voltage electrode unit 34, one or more ground electrodes 40, an upper coolant manifold 36, a lower coolant manifold 38, an inlet pipe 48 attached to the lower coolant manifold 38 and in fluid communication with the ground electrodes 40 and upper coolant manifold 36. The upper coolant manifold 36 is coupled to an outlet pipe 46 that is connected to a cooling system (not shown in FIG. 1 for brevity). Optionally, the electrode assembly 30 includes one or more spacers 42 for separating the high-voltage electrode unit 34 from the ground electrodes 40 so that the high-voltage electrode unit 34 may be arranged in a spaced-apart relationship with the ground electrodes 40.

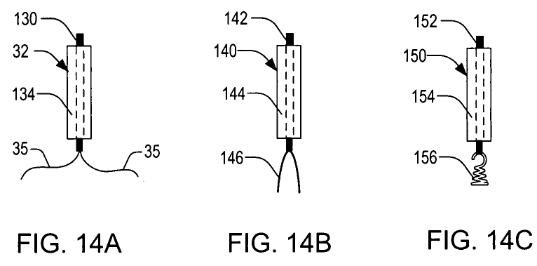

The ground electrodes 40 are disposed circumferentially about the longitudinal axis of the high-voltage electrode unit 34, positioned in parallel to the unit 34, and secured to the unit 34 by one or more retaining rings 44. Both ends of each ground electrode 40 are respectively connected to the upper coolant manifold 36 and lower coolant manifold 38 such that the ground electrodes are in fluid communication with the upper and lower coolant manifolds. The high-voltage electrode unit 34 is coupled to a power supply 50 via high-voltage feed-through 32 securely mounted in the top end wall 16. The high-voltage feed-through 32 is detailed in conjunction with FIGS. 14A-14C. It is noted that only one high-voltage feed-through 32 is shown in FIG. 1. However, it should be apparent to those of ordinary skill in the art that the device may include more than one high-voltage feed-through such that each high-voltage feed-through is coupled to the power supply 50 and a corresponding high-voltage electrode unit.

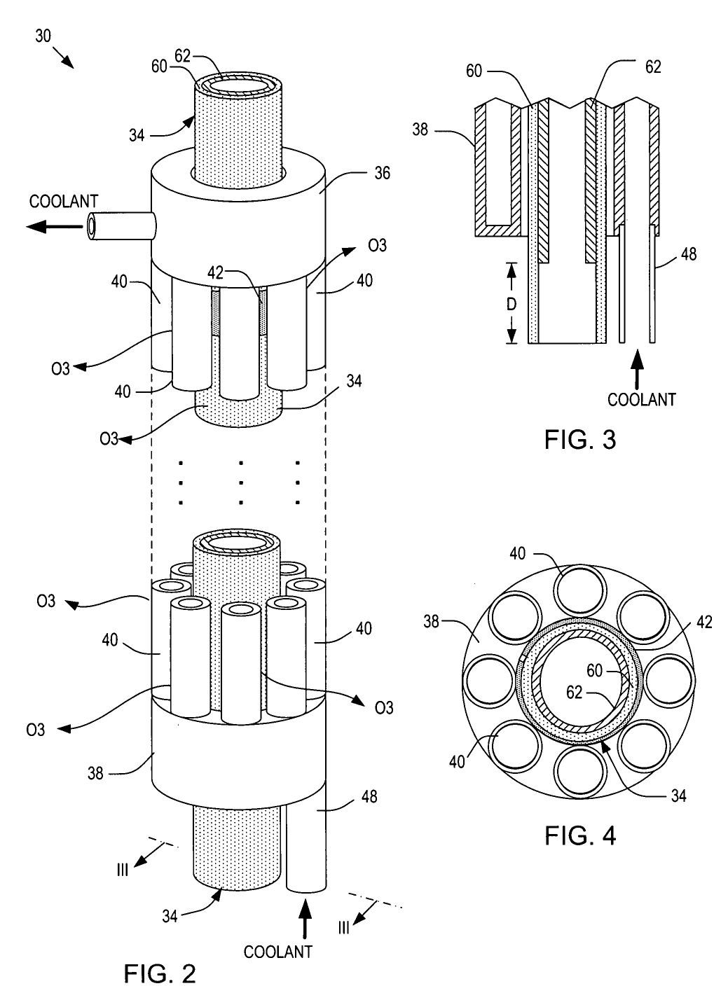

FIG. 2 shows a schematic perspective view of an electrode assembly 30 in FIG. 1. As depicted in FIGS. 1 and 2, the high-voltage electrode unit 34 includes an elongated dielectric tube 60 and a conducting layer 62 disposed on the inner surface of the dielectric tube. The dielectric tube 60 is formed of electrically insulating material, such as glass or ceramic. As will be discussed in conjunction with FIGS. 13A-13C, the conducting layer 62 may be a conducting rod or tube while the dielectric tube 60 may be formed by coating a dielectric layer on the outer surface of the conducting rod or tube. As such, the terms dielectric tube, dielectric layer, and dielectric member are used interchangeably hereinafter. Likewise, the terms conducting layer, conducting tube, and conducting member are used interchangeably for the similar reasons. The conducting layer 62 is made of a thin metallic foil, such as 0.025 mm-thick stainless steel foil, and secured to the inner surface of the dielectric tube 60. Alternatively, the conducting layer 62 is formed by coating the inner surface of the tube 60 with metal, such as silver. One end of the conducting wire 35 (in FIG. 1) is secured to the conducting layer 62 such that the conducting layer 62 operates as an electrode. The inner and outer diameters of the dielectric tube 60 are preferably, but not limited to, 12 mm and 14 mm, respectively.

Each of the ground electrodes 40 has a generally elongated tubular shape and arranged parallel to the high-voltage electrode unit 34. The transverse cross section of the ground electrode 40 may be of any suitable shape, such as a ring shaped cross section shown in the present document for the purpose of illustration. The ground electrodes 40 are formed of material that is both electrically and thermally conductive, such as metal, and grounded via the inlet pipe 48 or outlet pipe 46. The inner and outer diameters of the ground electrode 40 are preferably, but not limited to, about 5 mm and 6 mm, respectively. The ground electrodes 40 and conducting layer 62 of the high-voltage electrode unit 34 form a pair of electrodes for generating ozone through the plasma (or, equivalently corona discharge) established between the dielectric tube 60 and ground electrodes 40 during operation.

The power source 50 (FIG. 1) generates an alternating current preferably at the frequency of about 900 Hz and peak-to-peak voltage of 16 KV, or at other suitable frequencies and voltages. When the power supply 50 applies the alternating electrical potential across the conducting layer 62 and ground electrodes 40, a corona discharge is established between the dielectric tube 60 and ground electrodes 40. A portion of the energy of the corona discharge is converted into heat energy that if not dissipated will increase the temperatures of gas in the working space 13, ground electrodes 40, high-voltage electrode unit 34, and container 12. The heat energy also increases the temperature of as the gas in the corona discharge itself. The coolant passing through the ground electrodes 40 extracts the heat energy and flows through the upper coolant manifold 36 and outlet pipe 46, thereby to transfer the extracted heat energy to a cooling system. A conventional cooling system based on suitable coolant, such as Freon® or water, can be used to dissipate the heat energy from the device 10.

The coolant received from a cooling system through the inlet pipe 48 is distributed to the ground electrodes 40 by the lower coolant manifold 38 and collected and directed to the outlet pipe 46 by the upper coolant manifold 36. Each of the upper and lower coolant manifolds 36, 38 is a generally cylindrical container having top and bottom end walls with the high-voltage electrode unit 34 penetrating through the end walls, i.e., the manifolds 36, 38 have a generally hollow ring shape. The manifolds 36, 38 are formed of electrically conducting material, such as stainless steel. The inlet pipes 48 and outlet pipe 46 are formed of preferably, but not limited to, stainless steel.

FIG. 3 shows a schematic cross sectional view of the bottom portion of the electrode assembly 30 in FIG. 2, taken along the line III-III. As depicted, the conducting layer 62 does not extend down to the bottom end of the dielectric tube 60, i.e., the bottom end of the conducting layer 62 is recessed from the bottom end of the dielectric tube 60 by a distance D, to obviate an electric arc between the coolant tube 48 and the conducting layer 62.

The device 10 can operate as an ozone storage system. Upon filling the container 12 with a predetermined volume of oxygen gas, the inlet valve 22 and outlet valve 20 are closed and the power supply 50 provides an alternating current to the electrode assemblies 30 such that the assemblies 30 convert the oxygen gas into ozone gas until the ozone concentration reaches the intended level. Then, the power supply 50 becomes dormant and the device 10 enters a storage phase until the ozone gas is discharged through the outlet valve 20.

During the storage phase, an optional feedback control system 41 can be used to maintain the ozone concentration level. It is well known that ozone gas continuously decays back into oxygen gas. The ozone sensor 23b (or the sensor 23a) measures the ozone concentration and sends an electrical signal commensurate with the concentration to the feedback control system 41. If the ozone concentration in the container 12 decreases below the intended level due to the natural decay, the feedback control system 41, which can include a microprocessor, sends a signal to reactivate the power supply 50 so that the electrode assemblies 30 regenerate ozone gas to make up for the loss of ozone due to the natural decay and thereby to restore and maintain the concentration level.

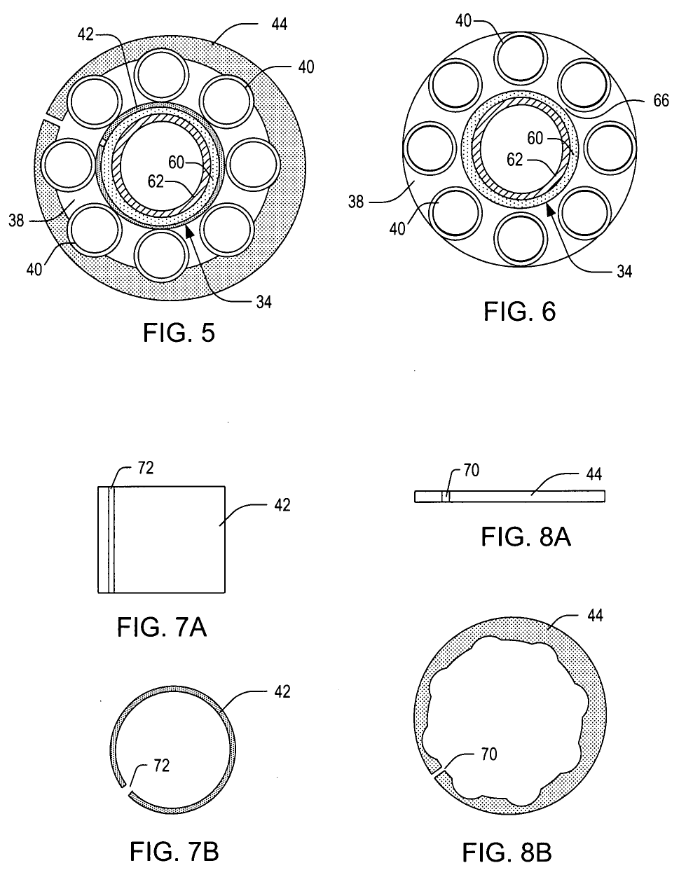

FIG. 4 shows a schematic cross sectional view of the electrode assembly 30 in FIG. 1, taken along the line IV-IV. As depicted, the ground electrodes 40 are separated from the high-voltage electrode unit 34 by a spacer 42. The spacer 42 is described in detail with reference to FIGS. 7A and 7B. FIG. 5 shows a schematic cross sectional view of the electrode assembly 30 in FIG. 1, taken along the line V-V. As depicted, the retaining ring 44 holds the ground electrodes 40 in place with respect to the high-voltage electrode unit 34, while the ground electrodes 40 are spaced-apart from the unit 34 by spacers 42. The retaining ring 44 is described in detail with reference to FIGS. 8A and 8B. In FIG. 1, it is shown that each electrode assembly 30 includes three spacers and two retaining rings. However, it should be apparent to those of ordinary skill that other suitable number of spacers and retaining rings may be used without deviating from the spirit of the present teachings.

FIG. 6 shows a schematic cross sectional view of the electrode assembly 30 in FIG. 1, taken along the line VI-VI. As depicted, the high-voltage electrode assembly unit 34 is separated from the ground electrodes 40, forming a discharge gap 66. When the power supply 50 applies an electrical potential across the conducting layer 62 and ground electrodes 40, a plasma or corona discharge is established in the gap 66 and a portion of the energy of the corona discharge converts oxygen gas into ozone gas while the remaining energy is converted into heat energy and dissipated by the coolant passing through the ground electrodes 40.

FIGS. 7A and 7B show schematic side and top views of the spacer 42 in FIG. 1. As depicted, the spacer 42 has a gap 72 and is disposed in the discharge gap 66 between the high-voltage electrode unit 34 and ground electrodes 40. As such, the size of the gap 66 (FIG. 6) is determined by the thickness of the spacer 42. The spacer 42 can be formed of any suitable material including stainless steel, plastic or Teflon®, and soft material, such as Teflon®, is preferred. As discussed above, the spacer 42 is an optional components, i.e., the spacer 42 may not be used in certain embodiments of the electrode assembly 30. In an alternative embodiment, the spacer has a closed ring shape, i.e., the space does not have a gap.

FIGS. 8A and 8B show schematic side and top views of the retaining ring 44 in FIG. 1. As depicted, the inner surface of the retaining ring 44 is contoured to follow the outer surfaces of the ground electrodes 40 in order to establish and maintain a uniform spacing between the electrodes 40. The retaining ring 44 is an external retaining ring with a gap 70 and formed of elastic material, such as spring tempered stainless steel for the purpose of holding the ground electrodes 40 in contact with the spacer 42.

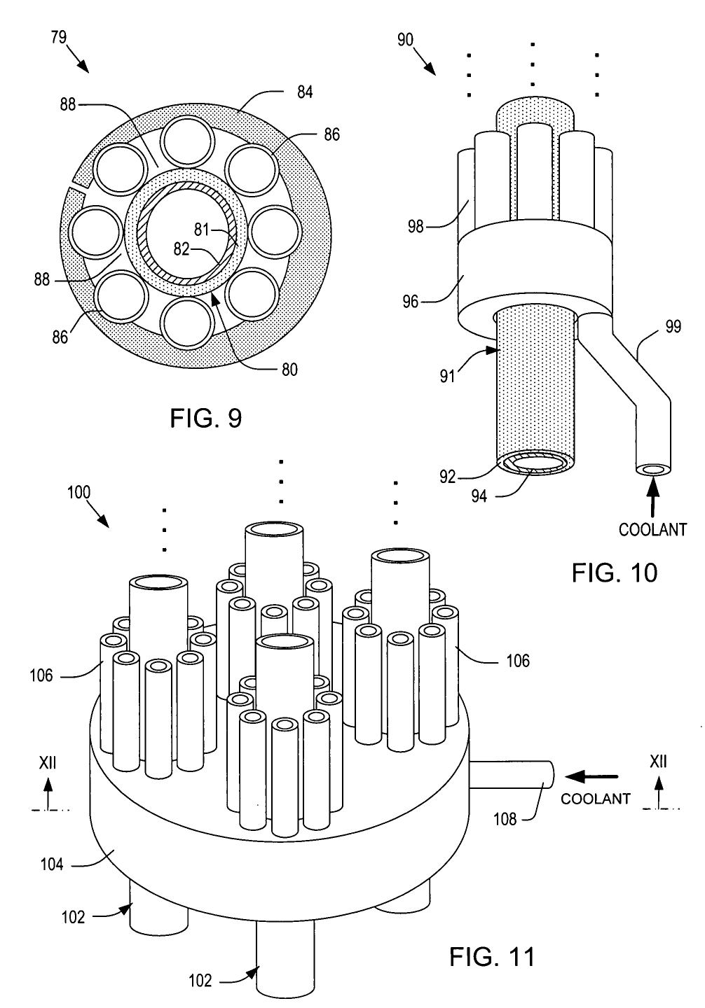

As discussed above, the spacer 42 may not be used in certain embodiments of the presently claimed invention. FIG. 9 shows a schematic transverse cross sectional view of another embodiment of an electrode assembly 79 of the type that might be used in the device 10 of FIG. 1 in accordance with the present invention. As depicted, the electrode assembly 79 is similar to the assembly 30 in FIG. 5, with the difference that the electrode assembly 79 does not include any spacer disposed between the dielectric tube 81 of a high-voltage electrode unit 80 and ground electrodes 86, i.e., the ground electrodes 86 are in direct contact with the dielectric tube 81, forming discharge gaps 88. The retaining ring 84 holds the ground electrodes 86 in direct contact with the dielectric tube 81.

FIG. 10 is a schematic perspective view of another embodiment of an electrode assembly 90 of the type that might be used in the device 10 of FIG. 1 in accordance with the present invention. For brevity, only the bottom portion of the electrode assembly 90 is shown in FIG. 10. As depicted, the electrode assembly 90 is similar to the electrode assembly 30 in FIG. 2, with the difference that an inlet pipe 99 is bent to separate it away from a high-voltage electrode unit 91, thereby increasing the lateral distance between the tip of a conducting layer 94 and the pipe 99 in order to obviate an electric arc therebetween. In an alternative embodiment, the bottom end of the conducting layer 94 may be recessed from the bottom end of the dielectric tube 92 as in FIG. 3 for the same reasons.

In another alternative embodiment, the top portion of an electrode assembly may have a similar structure as the bottom portion of the assembly 90 in FIG. 10. In this embodiment, an outlet pipe from the upper coolant manifold of the electrode assembly extends through the top end wall 16 of the container and is connected to a cooling system, forming a circulation passageway for the coolant.

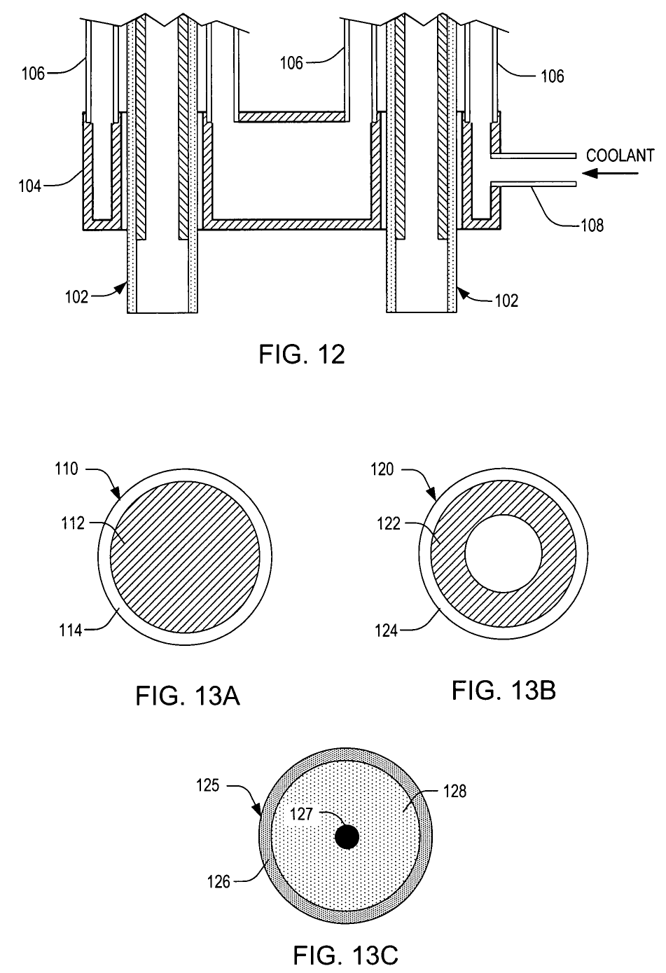

FIG. 11 shows a schematic perspective view of still another embodiment of an electrode assembly 100 of the type that might be used in the device 10 of FIG. 1 in accordance with the present invention. FIG. 12 shows a schematic cross sectional view of the electrode assembly 100, taken along the line XII-XII. As depicted, the electrode assembly 100 includes a plurality of high-voltage electrode units 102 passing through a lower coolant manifold 104. Ground electrodes 106 are disposed circumferentially about the longitudinal axis of the each unit 102 and coupled to the lower coolant manifold 104. The upper portion of the assembly 100 is similar to the lower portion in FIG. 11 with the difference that the coolant provided through the inlet pipe 108 to the lower coolant manifold 104 exits from the upper coolant manifold. For brevity, the upper portion of the electrode assembly 100 is not shown in FIG. 11. It is noted that the coolant can enter the bottom, side, or even top of the manifold 104 while FIG. 11 illustrates only the side entrance of the coolant as an example.

In an exemplary embodiment, the lower coolant manifold 104 is disposed within the working space 13 (FIG. 1). In another exemplary embodiment, the top and bottom manifolds are respectively made integral with top and bottom end walls 16, 18 (FIG. 1), with the dielectric tubes penetrating (and sealed to) the walls. In this embodiment, the high voltage connections are formed on the outside of the container 12, i.e., the high-voltage feed-through 32 is not necessary.

FIG. 13A is a schematic transverse cross sectional view of an embodiment of a high-voltage electrode unit 110 of the type that might be in the device 10 of FIG. 1 in accordance with the present invention. As depicted, the high-voltage electrode unit 110 includes: a conducting rod 112 that has a generally cylindrical rod shape and made of electrically conducting material, such as metal; and dielectric layer 114 coated on the outer surface of the conducting rod 112 and made of dielectric material, such as glass or ceramic.

FIG. 13B is a schematic transverse cross sectional view of another embodiment of a high-voltage electrode unit 120 of the type that might be in the device 10 of FIG. 1 in accordance with the present invention. As depicted, the high-voltage electrode unit 120 includes: a conducting tube 122 made of electrically conducting material, such as metal; and dielectric layer 124 coated on the outer surface of the conducting rod 122 and made of dielectric material, such as glass or ceramic.

FIG. 13C is a schematic transverse cross sectional view of yet another embodiment of a high-voltage electrode unit 125 of the type that might be in the device 10 of FIG. 1 in accordance with the present invention. As depicted, the high-voltage electrode unit 125 includes: a sealed dielectric tube 126 defining an elongated enclosed space therein; a conducting rod 127 made of electrically conducting material, such as metal, and disposed inside the space; and ionizable gas 128 filled in the space. One end of the conducting rod 127 penetrates the dielectric tube 126 to conduct high voltage from a power supply to the ionizable gas 128. During operation, the ionized gas is ionized such that an electrical potential is applied across the ionizable gas and the ground electrodes.

FIG. 14A shows the high-voltage feed-through 32 of FIG. 1. As depicted, the high-voltage feed-through 32 includes an electrically insulating tube 134 that extends through the top end wall 16 and a conducting rod 130 that is mounted in the tube 134 and secured to the inner surface of the tube 134. One end of the flexible conducting wire 35 is coupled to the rod 130 and the other end is coupled to the conducting layer 62, for instance. The insulating tube 134 is formed of electrically insulating material, such as ceramic, and secured to the upper end wall 16.

FIG. 14B shows another embodiment of a high-voltage feed-through 140 of the type that might be in the device 10 of FIG. 1 in accordance with the present invention. As depicted, the high-voltage feed-through 140 is similar to the feed-through 32 in FIG. 14A, with the difference that a spring tempered wire 146 is attached to the conducting rod 142 in place of the conducting wire 35. The spring tempered wire 146 is formed of electrically conducting material. The bottom tips of the spring tempered wire 146 are squeezedly inserted into the inner surface of the conducting layer 62 (FIG. 2), thereby secured to the conducting layer 62 by a resilient force. Alternatively, an elastic metal leaf may be used in place of the spring tempered wire 146.

FIG. 14C shows yet another embodiment of a high-voltage feed-through 150 of the type that might be in the device 10 of FIG. 1 in accordance with the present invention. As depicted, the high-voltage feed-through 150 is similar to the feed-through 32 in FIG. 14A, with the difference that a spring 156 is attached to the conducting rod 152 in place of the wire 35. The spring 156 is formed of electrically conducting material and secured to the conducting layer, such as 112 (FIG. 12), of a high-voltage electrode assembly.

The device 10 can operate in either continuous mode or batch mode. In the continuous mode, both the inlet value 22 and outlet valve 20 are open so that at least a portion of the oxygen gas flow received through the inlet valve 22 is converted into ozone gas and the ozone gas (or a mixture of oxygen/ozone gas) continuously exits the outlet valve 20. In the batch mode, oxygen gas is received through the inlet valve 22 while the outlet valve 20 is closed. When the container 12 is filled with a predetermined quantity of oxygen gas, the inlet valve 22 is closed and the oxygen gas in the container 12 is converted into ozone gas until the ozone concentration reaches the intended level. Then, as discussed above, the device 10 enters a storage phase until the ozone gas is discharged through the outlet valve 20.

The device 10 can be applied to various applications that require a periodic or intermittent use of ozone gas; some requiring a large quantity of ozone gas in the shortest time possible. An example of this type of application would be a batch type sterilization process. In a typical batch type sterilization process using ozone, a sterilization chamber is first loaded with the articles to be sterilized. Then, the chamber is evacuated and then backfilled with ozone. Conventionally, the chamber is filled with ozone as it is produced by an ozone generator. The time required to backfill the chamber with ozone is determined by the rate of production of the ozone, which is in turn determined by the size of the ozone generator. Because backfill time is part of the overall cycle time, it is desirable for the backfill time to be as short as possible. Even a very large conventional ozone generator may require several minutes to fill a typical sterilizer chamber. In contrast, the device 10 in the storage phase is able to provide a sufficient quantity of ozone pre-prepared in the container 12 and thereby ready to immediately transfer the ozone to the sterilization chamber upon demand. The device 10 can also replenish the oxygen in the container 12 after the ozone has been transferred to the sterilizer and again, regenerate the ozone in the container for the next sterilization cycle.

It should be understood, of course, that the foregoing relates to exemplary embodiments of the invention and that modifications may be made without departing from the spirit and scope of the invention as set forth in the following claims.

What is claimed is:

1. A device for generating ozone, comprising:
at least one elongated electrode unit including an outer tubular dielectric member and an inner conducting member having a longitudinal axis; and
one or more elongated electrode tubes disposed circumferentially about said longitudinal axis and in parallel to said electrode unit,
wherein said conducting member and electrode tubes are operative to generate plasma between said dielectric member and said electrode tubes when an electrical potential is applied across said conducting member and said electrode tubes during operation and said plasma converts oxygen gas into ozone gas.

2. A device as recited in claim 1, further comprising:
at least one spacer having generally the shape of a ring and disposed between said electrode unit and said electrode tubes such that said electrode unit is spaced-apart relative to said electrode tubes.

3. A device as recited in claim 1, further comprising:
at least one retaining ring for holding said electrode tubes in place with respect to said electrode unit.

4. A device as recited in claim 3, wherein the inner surface of said retaining ring is contoured to follow the outer surfaces of said electrode tubes.

5. A device as recited in claim 1, wherein said conducting member includes a metallic foil secured to the inner wall of said dielectric member.

6. A device as recited in claim 1, wherein said conducting member includes a metal coating applied to the inner surface of said dielectric member.

7. A device as recited in claim 1, wherein said conducting member includes an electrically conducting rod and said dielectric member includes a dielectric coating applied to the outer surface of said electrically conducting rod.

8. A device as recited in claim 1, wherein said conducting member includes an electrically conducting tube and said dielectric member includes a dielectric coating applied to the outer surface of said electrically conducting tube.

9. A device as recited in claim 1, wherein said outer tubular dielectric member is sealed to form an enclosed space therewithin and wherein said inner conducting member includes a conducting rod disposed within said space and an ionizable gas filled within said space, one end of said inner conducting member penetrating said outer tubular dielectric member.

10. A device as recited in claim 1, wherein said electrode tubes are grounded.

11. A device as recited in claim 1, further comprising:
a container having one or more walls to define an enclosed working space for containing gas therein,
wherein said electrode unit and electrode tubes are disposed in said working space.

12. A device as recited in claim 11, further comprising:
a first coolant manifold operative to receive coolant from a cooling system; and
a second coolant manifold operative to send the coolant to the cooling system, two ends of each said electrode tube being respectively coupled to said first and second coolant manifolds such that said first and second coolant manifolds are in fluid communication with said electrode tubes.

13. A device as recited in claim 12, wherein said first coolant manifold and second coolant manifold are disposed in said working space.

14. A device as recited in claim 13, further comprising:
at least one inlet coolant pipe extending from said first coolant manifold to the cooling system through one of said walls; and
at least one outlet coolant pipe extending from said second coolant manifold to the cooling system through one of said walls.

15. A device as recited in claim 14, wherein at least one of said inlet and outlet coolant pipes is grounded.

16. A device as recited in claim 12, wherein at least one of said first coolant manifold and second coolant manifold is formed integral with said wall of said container.

17. A device as recited in claim 11, further comprising:
an inlet valve for introducing the oxygen gas into said container; and
an outlet valve for discharging the ozone gas from said container.

18. A device as recited in claim 11, further comprising:
at least one high-voltage feed-through including:
an electrically insulating tube extending through and secured to one of said walls of said container; and
a conducting rod mounted in and secured to said insulating tube and having first and second tips; and
a conducting component for electrically connecting the first tip of said conducting rod to said conducting member,
wherein said second tip of said conducting rod is to be coupled to a power supply for applying the electrical potential.

19. A device as recited in claim 18, wherein said conducting component includes a flexible conducting wire.

20. A device as recited in claim 18, wherein said conducting component is a spring tempered wire, a spring, or an elastic metal leaf.

21. A device as recited in claim 11, further comprising:
an ozone sensor operative to measure the ozone concentration of gas and to generate an electrical signal commensurate with the concentration.

22. A device as recited in claim 21, further comprising:
a feedback control system responsive to the electrical signal generated by said ozone sensor and operative to control a power supply for applying the electrical potential.

23. A device as recited in claim 21, further comprising:
a pipe having a first end in fluid communication with a top portion of said container and a second end in fluid communication with a bottom portion of said container such that the gas contained in said container flows through said pipe by a thermal siphon effect.

24. A device as recited in claim 23, wherein said ozone sensor is coupled to said pipe to measure the ozone concentration of the gas flowing through said pipe.
